(19) United States
(12) Patent Application Publication
(10) Pub. No.: US 2011/0170378 A1
(43) Pub. Date: Jul. 14, 2011

(54) METHOD AND APPARATUS FOR MONITORING MEDICATION INTAKE BY PATIENTS

(76) Inventors: David HOLD, Aventura, FL (US); Christina Mendez, Fort Lauderdale, FL (US)

(21) Appl. No.: 13/004,267

(22) Filed: Jan. 11, 2011

Related U.S. Application Data
(60) Provisional application No. 61/294,165, filed on Jan. 12, 2010.

(51) Int. Cl. G04B 47/00

(52) U.S. Cl. 368/10

(57) ABSTRACT

A system and method are described that include a microprocessor based entity receiving prescriptions from many different patients. A schedule is generated for each prescription and at an appropriate time a reminder is sent to each patient to take his drug. Optionally, each patient can acknowledge receiving the reminder, and/or the drug. If no acknowledgement is received, a third party, such as a care provider or a relative is automatically informed.

### RELATED APPLICATIONS

This application claims priority to provisional application Ser. No. 61/294,165 filed Jan. 12, 2010 and incorporated herein by reference in its entirety.

### BACKGROUND OF THE INVENTION

a. Field of Invention

This invention pertains to a method and apparatus for monitoring whether patients are taking their prescribed medicines from a remote location.

b. Background of the Invention

Patients suffering various kinds of illnesses and other health-related issues are frequently prescribed medication that should be taken at regular intervals. These intervals may range from several hours to several days. Very often, patients have to take different medications at different times, with some of the medications being taken orally, while other may have to be injected or otherwise introduced or applied. Failure to take some or all of this medication can have serious consequences to the patient's health. However, it is believed that in fact many patients do not take their medication as required. This is especially frequent with elder patients who may forget or may get confused as to what medication they are required to take and/or when. At other times, elderly patients may take a medication inadvertently more often than required.

Various devices have been tried in the passed to solve this problem. For example, drug containers are available that have several compartments with some indication or label indicating when the contents of each compartment are to be taken. Other devices include electronic timers that announce to the patients when a medication needs to be taken.

However all these devices proved to be ineffective and too complicated.

### BRIEF DESCRIPTION OF THE FIGURES

FIG. 1 shows a block diagram of a system incorporating the present invention;

FIG. 2 shows a block diagram of a patient monitor apparatus used in the system of FIG. 1;

FIG. 3 shows a flow chart illustrating a patient registration stage; and

FIG. 4 shows a flow chart of the operation of the patient monitor.

### DESCRIPTION OF THE INVENTION

The present invention provides a simple and yet effective means of overcoming the problems described above. Several embodiments are described that not only remind the patient from a remote location at the right time to take a drug but, at least in some of the embodiments, provide a positive indication that the reminder has been received and acknowledged by the patient. These features alone and in combination, insure that patients receive proper care for their ailment.

In the following embodiments, it is assumed that a patient has been dispensed one or more medications and that he has been issued proper instructions on when and how to take the medications. The same information is simultaneously provided to a remote agent, e.g., an agent that is located outside the patient's home. This agent is an automated apparatus that, in one embodiment, automatically contacts the patient at a designated date and time related to when the patient needs to take the medication.

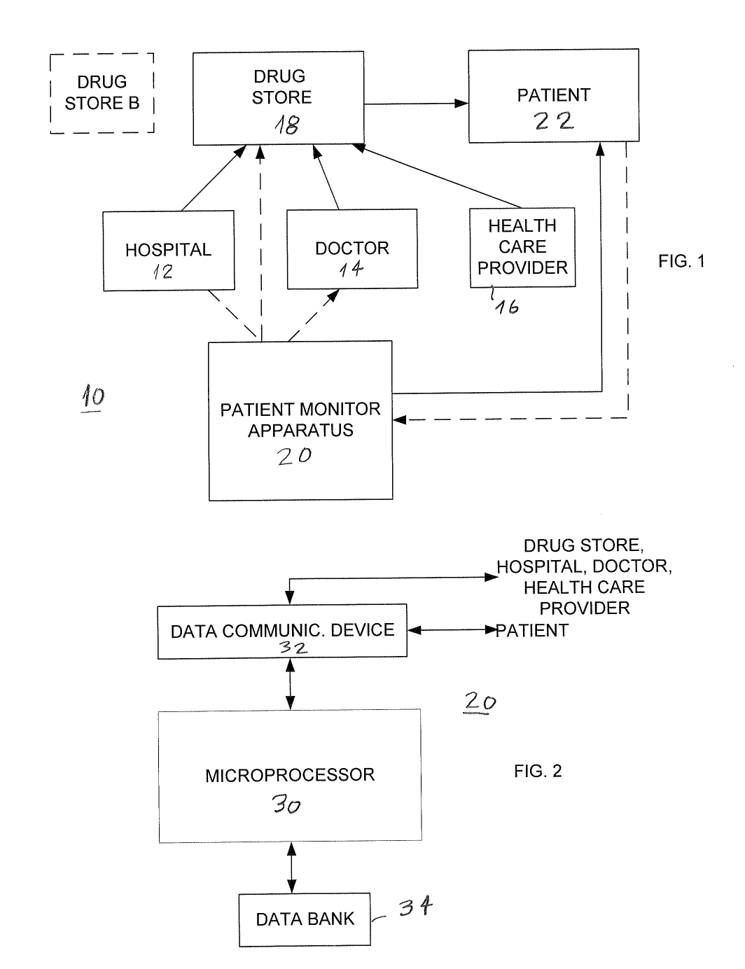

More particularly, as shown in FIG. 1, in a system 10 in accordance with this invention, a health care provider such as a hospital 12, a doctor 14, or other health care professional or entity 16 provides a prescription for a patient. This prescription is either transmitted directly to a drug store A (or other similar dispensing entity) 18 or is given to a patient who then presents it to the drug store A 18. This information is also sent to a patient monitor apparatus 20 by any one of the prescription suppliers, or by some other entity, such as a health insurance company. The insurance company receives the information from the drug store 18 or by other means.

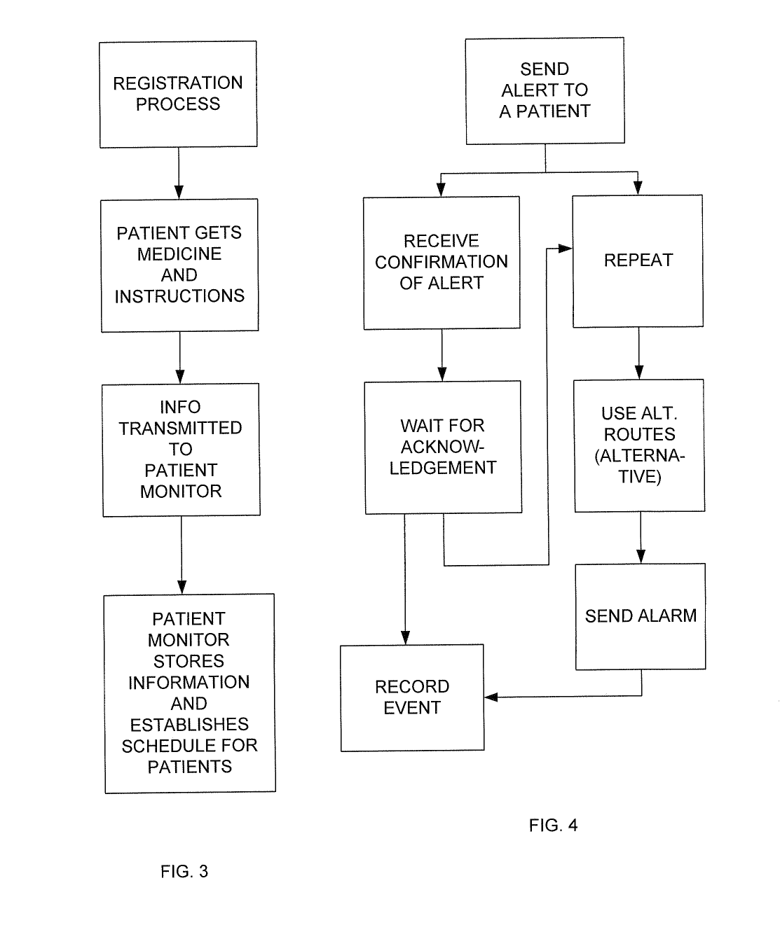

Referring to FIG. 2, the patient monitor apparatus (or patient monitor, for short) 20 includes a microprocessor 30, a transceiver or other data communication device 32 and a data bank 34. The data bank 34 is used to store all information relevant to various patients 22 in the system 10, including the information related to a particular prescription for one of the patients. As part of the step of collecting the information, as shown in FIG. 3, the patient registers and provides his critical information related to his health, as well as one more communications channels by which he can, or prefers to be reached. It should be noted that, except for the last part, all the other information is already required under various applicable laws by the drug store. Moreover, all the entities described, including the patient monitor 20 is arranged and configured to maintain this patient information secret and safe, again, in accordance with the applicable laws.

The patient 22 then receives the medication and relevant instructions from the respective health care provider 12, 14, 16 and/or the drug store 18, including when to take the medication, how often, and any other special instructions, such as whether to take the medication before or after a meal, and/or whether the medication should be taken certain foods or liquids, etc.

The instructions to the patient are also transmitted to the patient monitor 20 by the health care provider and/or the drug store 18. The patient monitor 20 stores all this information and also establishes a schedule for prescription, including the medication and the special instructions specific to each patient 20.

Once the schedule is established, the patient monitor 20 operates as shown in the flow chart of FIG. 4. That is, at a prescribed date and time, for example, the patient monitor 20 sends an automated alert message to the patient 22. The mode of transmission and the form of the alert message is dependent on the patient's preferences, his location, his devices, etc. Possible modes of transmission could over a standard land-line telephone line, in which case the alert message typically consists of a voice mail indicating what medicine should be taken, when and any special instructions. Of course, preferably the message is sent to patient 20 at least a couple of minutes before the medicine is to be taken. Alternatively, the voice alert message could be sent to a cellular telephone, a pager, a VOIP device or other audible devices.

In another embodiment of the invention, the alert message is sent by the patient monitor 20 as a text message to a cell phone, an e-mail address, a beeper, a pager, etc.

In the simplest embodiment, the alert message goes out to the patient, and a record is made by the microprocessor 30 that the message was sent. The record of all messages are kept and presented to any authorized entity when requested.

In a more complex embodiment, the patient monitor 20 is configured to determine whether the alert message was actually received by determining either that the alert message was delivered to a live person or that it was recorded by an answering machine. For example, when a verbal message is sent to the patient 20, the patient may be requested to confirm that he has received the instructions by saying “YES”, by pressing the number “1” on his telephone, etc. If no confirmation is received within a predetermined time, then alert message is resent. The alert message can be resent in this manner several times. After N such tries, if confirmation is still not received then an appropriate record is stored for the patient 22. In addition, or alternatively, a separate message is sent to an appropriate entity (a health care provider (e.g., 12, 14) or a designated relative) to indicate that the alert message could not be delivered. A similar process is performed if a text message is sent to the patient 22.

In another embodiment, instead of, or in addition to confirmation, the patient monitor 20 is also configured to receive an actual acknowledgement from the patient either that he has received the alert message, or that he has actually taken the medication. For example, either in the original message, or in a follow up message, the patient is asked to say “YES” or push the number “1” if he has taken the medicine, and say “NO” or push the number “2” if he has not taken the medicine. The same process can be used to obtain an acknowledgement to a text message. Again, if such a positive acknowledgement is expected, the patient monitor waits for a predetermined time for it, and if it is not received, the alert message is resent. If no acknowledgement is received, a record of this event is made and an appropriate alert message is sent to the appropriate entities, e.g. the health care provider and/or a relative. As previously indicated, the acknowledgment can be initiated by the patient by merely pushing a button on his land line or cell phone when he receives the alert message, or by sending a separate message to the patient monitor using any convenient channel.

Returning to the system of FIG. 1, the patient monitor can be made an integral part of any of the entities generating the prescription, the drug store, or some other entity providing other services for any of the parties discussed. Moreover, the system can be easily implemented even if the patient goes to several different drug stores, such as drug store B.

If a given patient is prescribed several medications, the alert message can cover all them, or alternatively, several alert messages can be sent to the same patient as required.

The information recorded from the patient can be made available to the doctor, the hospital, the drug store, the insurance company, to insure that the patient is taking his medicine or for various medical studies. Moreover, the patient monitor is further adapted to aggregate the data in the data bank 34 and generate various reports that do not include the actual patient identification, such as how many patients were prescribed drug X in a given month, how many patients actually took drug X in that month, how many patients obtained their drugs from drug store A, how many patients obtained their drugs from drug store B and so forth.

Another type of report may indicate information about which health care provider or how many health care providers prescribed a drug Y as opposed to a similar drug Z, how often was a patient instructed to take a drug, etc.

Another type of report may be include a cost analysis based on what various drug stores charged for either a specific drug, or a specific type of drug.

Obviously numerous modifications can be made to this invention without departing from its scope as defined in the appended claims.

We claim:

1. In a microprocessor-based device, a method of monitoring drug intake by a patient comprising the steps of:
receiving a prescription for a drug for a particular patient indicating a time for the taking of the drug by the patient;
generating by said device a time schedule of the dates and times when the patient is to take the medicine;
generating at the appropriate time a message to the patient indicating that the drug should be taken by the patient; and
sending said message to the patient.

2. The method of claim 1 wherein prescription is received automatically from a drug store.

3. The method of claim 1 wherein said message is an oral message.

4. The method of claim 3 wherein said message is transmitted over a telephone.

5. The method of claim 3 wherein said message is a text message.

6. The method of claim 1 further comprising the step of receiving a return signal from the patient.

7. The method of claim 6 wherein said return signal includes information indicating that the patient has received said message.

8. The method of claim 6 wherein said return signal includes information indicating that the patient has taken the drug.

9. The method of claim 6 wherein said return signal indicates that the patient has not acknowledged receiving said message.

10. The method of claim 1 further comprising recording data indicating that said message was sent.

11. The method of claim 6 further comprising recording data indicating that said message was sent and information from said return signal.

12. The method of claim 6 further comprising generating another message to a third party providing information regarding said message.

13. An automated apparatus for monitoring of drug intake of patients based on prescription comprising:
a data communication device receiving a prescription for a drug for a particular patient, said prescription including frequency information indicating when the drug is to be taken by the patient;
a microprocessor receiving said prescription and being configured to generate a schedule based on said prescription, said schedule defining the times when reminder messages must be sent to the patient, said microprocessor further being configured to generate said reminder messages at predetermined times as determined by said schedule; and
a data base used by the microprocessor for recording events related to said prescription and said reminder messages.

14. The automated apparatus of claim 13 wherein said reminder message is sent by a land line.

15. The automated apparatus of claim 13 wherein said reminder message is sent to a cell phone.

16. The automated apparatus of claim 13 wherein said microprocessor is further configured to receive response messages in response to said reminder messages.

17. The automated apparatus of claim 13 wherein said response message indicate at least one of several events, including an acknowledgement that said reminder message has been received, and an acknowledgement that the drug has been taken by the patient.

18. The automated apparatus of claim 17 wherein said reminder and said response messages are stored in said data base.

19. The automated apparatus of claim 13 wherein said microprocessor is configured several prescriptions for several patients and to generate respective reminder messages to said patients.

20. The automated apparatus of claim 19 wherein said microprocessor is further configured to compile information related to various drugs defined by said prescriptions and store said information in said data base.
